(19) United States
(12) Patent Application Publication
(10) Pub. No.: US 2024/0347727 A1
(43) Pub. Date: Oct. 17, 2024

(54) ELECTROCHEMICAL APPARATUS AND ELECTRONIC APPARATUS INCLUDING ELECTROCHEMICAL APPARATUS

(71) Applicant: Dongguan Amperex Technology Limited, Dongguan (CN)

(72) Inventors: Chenchen LI, Dongguan (CN); Ping HE, Dongguan (CN); Daolin LIU, Dongguan (CN); Jun CHEN, Dongguan (CN)

(73) Assignee: Dongguan Amperex Technology Limited, Dongguan (CN)

(21) Appl. No.: 18/672,400

(22) Filed: May 23, 2024

Related U.S. Application Data
(63) Continuation of application No. PCT/CN2021/132408, filed on Nov. 23, 2021.

(51) Int. Cl. H01M 4/583; H01M 4/02; H01M 4/04; H01M 50/48

(52) U.S. Cl. CPC H01M 4/583; H01M 4/0404; H01M 50/48; H01M 2004/021; H01M 2004/027

(57) ABSTRACT

An electrochemical apparatus, including: a first electrode assembly including a first negative electrode plate having a first negative current collector with a first negative active material layer disposed on at least one surface; and a second electrode assembly including a second negative electrode plate having a second negative current collector with a second negative active material layer disposed on at least one surface. A coating weight W_{1f} of the first negative active material layer and a coating weight W_{2f} of the second negative active material layer satisfy: 30 mg/1540.25 mm²≤W_{2f}−W_{1f}≤100 mg/1540.25 mm². By regulating a value of W_{2f}−W_{1f} to be within the above range, energy density of the electrochemical apparatus and swelling performance of the electrochemical apparatus can be improved while fast charging performance is satisfied.

### CROSS-REFERENCE TO RELATED APPLICATIONS

This application is a continuation application of PCT International Application No. PCT/CN2021/132408, filed on Nov. 23, 2021, the contents of which are incorporated herein by reference in its entirety.

### TECHNICAL FIELD

This application relates to the field of electrochemistry, and in particular, to an electrochemical apparatus and an electronic apparatus including the electrochemical apparatus.

### BACKGROUND

In recent years, a fast charging technology has brought great convenience to consumers, and a key to realization of the fast charging technology lies in usage of a fast-charging electrode assembly. However, the usage of the fast-charging electrode assembly causes loss of energy density of a lithium-ion battery. If conventional measures such as increasing compaction density of an active material layer and increasing a coating weight of the active material layer are used to increase the energy density of the lithium-ion battery, fast charging performance of the lithium-ion battery is reduced, and a swelling rate of the lithium-ion battery under a fast charging condition is deteriorated.

### SUMMARY

An objective of this application is to provide an electrochemical apparatus and an electronic apparatus including the electrochemical apparatus, to increase energy density of the electrochemical apparatus and improve swelling performance of the electrochemical apparatus.

A first aspect of this application provides an electrochemical apparatus, including: a packaging shell, a first electrode assembly, and a second electrode assembly, where the packaging shell is provided with an accommodation cavity, and the first electrode assembly and the second electrode assembly are disposed in the accommodation cavity; the first electrode assembly includes a first positive electrode plate and a first negative electrode plate, the first positive electrode plate includes a first positive current collector and a first positive active material layer disposed on at least one surface of the first positive current collector, and the first negative electrode plate includes a first negative current collector and a first negative active material layer disposed on at least one surface of the first negative current collector; the second electrode assembly includes a second positive electrode plate and a second negative electrode plate, the second positive electrode plate includes a second positive current collector and a second positive active material layer disposed on at least one surface of the second positive current collector, and the second negative electrode plate includes a second negative current collector and a second negative active material layer disposed on at least one surface of the second negative current collector; and a difference between a coating weight W_{1f} of the first negative active material layer and a coating weight W_{2f} of the second negative active material layer satisfies: 30 mg/1540.25 mm²≤W_{2f}−W_{1f}≤100 mg/1540.25 mm².

For example, a value of W_{2f}−W_{1f} may be 30 mg/1540.25 mm², 40 mg/1540.25 mm², 50 mg/1540.25 mm², 60 mg/1540.25 mm², 70 mg/1540.25 mm², 80 mg/1540.25 mm², 90 mg/1540.25 mm², 100 mg/1540.25 mm², or any value within a range between any two values above.

The coating weight W_{1f} of the first negative active material layer is less than the coating weight W_{2f} of the second negative active material layer, and the value of W_{2f}−W_{1f} is regulated to be within the above range, so that the first electrode assembly has a better fast charging and discharging capability than the second electrode assembly, can meet requirements of high-power consumption applications such as a game or video, and also has a significantly reduced risk of swelling during rapid charging and discharging. In addition, the coating weight War of the second negative active material layer is large, in other words, in a same area, the second negative active material layer has more active materials than the first negative active material layer. Because accumulation between active material particles can provide more pores, when the first electrode assembly swells in a rapid charge-discharge cycle process, the second negative active material layer can provide sufficient buffer space for the first electrode assembly, so that a risk of increasing an overall volume of the electrochemical apparatus is reduced, and the swelling performance of the electrochemical apparatus is improved.

In addition, the coating weight W_{1f} of the first negative active material layer is less than the coating weight W_{2f} of the second negative active material layer, and the value of W_{2f}−W_{1f} is regulated to be within the above range, an internal resistance of the first negative electrode plate is less than that of the second negative electrode plate, so that transmission kinetic performance of a lithium ion on the first negative electrode plate in the electrochemical apparatus can be improved. The first electrode assembly including the first negative electrode plate can be quickly fully charged at a high charging rate. The second electrode assembly including the second negative electrode plate can be quickly fully charged at a low charging rate. In this way, two electrode assemblies in the electrochemical apparatus are set as the first electrode assembly with a higher charge rate and of a fast charging type and the second electrode assembly with a lower charge rate and of an energy type. Therefore, fast charging performance of the electrochemical apparatus is ensured, and the second negative active material layer of the second electrode assembly can provide a larger capacity due to the larger coating weight, so that energy density of the electrochemical apparatus can be improved.

In an implementation solution of this application, the coating weight W_{1f} of the first negative active material layer is 50 mg/1540.25 mm² to 140 mg/1540.25 mm², and preferably 90 mg/1540.25 mm² to 140 mg/1540.25 mm². For example, the coating weight W_{1f} of the first negative active material layer is 50 mg/1540.25 mm², 60 mg/1540.25 mm², 80 mg/1540.25 mm², 100 mg/1540.25 mm², 120 mg/1540.25 mm², 140 mg/1540.25 mm², or any value within a range between any two values above. By regulating the coating weight W_{1f} of the first negative active material layer to be within the above range, the first electrode assembly can have both high energy density and high rate performance.

In an implementation solution of this application, a compaction density D_{1f} of the first negative active material layer is 1.5 g/cm³ to 1.8 g/cm³. For example, the compaction density D_{1f} of the first negative active material layer is 1.55 g/cm³, 1.65 g/cm³, 1.78 g/cm³, or any value within a range between any two values above. By regulating the compaction density D_{1f} of the first negative active material layer to be within the above range, the energy density of the first electrode assembly can be increased, and it is ensured that the first negative active material layer has appropriate pores, so as to improve the swelling performance of the electrochemical apparatus.

In an implementation solution of this application, the coating weight W_{2f} of the second negative active material layer is 130 mg/1540.25 mm² to 170 mg/1540.25 mm². For example, the coating weight W_{2f} of the second negative active material layer is 130 mg/1540.25 mm², 140 mg/1540.25 mm², 150 mg/1540.25 mm², 170 mg/1540.25 mm², or any value within a range between any two values above. By regulating the coating weight W_{2f} of the second negative active material layer to be within the above range, the second electrode assembly can have a large capacity, and the second negative active material layer can provide sufficient buffer space when a volume of the first electrode assembly swells during rapid charging and discharging, so as to improve the swelling performance of the electrochemical apparatus.

In an implementation solution of this application, a compaction density Der of the second negative active material layer is 1.5 g/cm³ to 1.8 g/cm³. For example, the compaction density Der of the second negative active material layer is 1.74 g/cm³, 1.75 g/cm³, 1.78 g/cm³, or any value within a range between any two values above. By regulating the compaction density Der of the second negative active material layer to be within the above range, energy density of the second electrode assembly can be increased, and sufficient pores of the second electrode assembly are ensured, so as to improve the swelling performance of the electrochemical apparatus.

In an implementation solution of this application, the first negative active material layer includes a first negative active material, the second negative active material layer includes a second negative active material, and satisfying at least one of the following conditions: (a) a specific surface area BET₁ of the first negative active material ranges from 1.6 m²/g to 2.0 m²/g; (b) a specific surface area BET₂ of the second negative active material ranges from 0.6 m²/g to 1.1 m²/g; (c) the first negative active material includes at least one of graphite or lithium titanate; and (d) the second negative active material includes at least one of the graphite or a silicon-carbon composite material, and a mass percentage W_{Si} of silicon in the silicon-carbon composite material ranges from 0.1% to 10%.

For example, the specific surface area BET₁ of the first negative active material is 1.6 m²/g, 1.7 m²/g, 1.8 m²/g, 1.9 m²/g, 2.0 m²/g, or any value within a range between any two values above. By regulating the specific surface area BET₁ of the first negative active material to be within the above range, this further helps improve the transmission kinetic performance of the lithium ion on the first negative electrode plate, and further helps reduce a risk of swelling of the second electrode assembly due to a side reaction caused by untimely deintercalation of the lithium ion during rapid charging and discharging of the first electrode assembly.

For example, the specific surface area BET₂ of the second negative active material is 0.6 m²/g, 0.7 m²/g, 0.8 m²/g, 0.9 m²/g, 1.0 m²/g, 1.1 m²/g, or any value within a range between any two values above. By regulating the specific surface area BET₂ of the second negative active material to be within the above range, this further helps increase a capacity of the second negative electrode plate, and further helps increase the energy density of the electrochemical apparatus.

The first negative active material includes at least one of the graphite or the lithium titanate. The foregoing material is selected as the first negative active material, so that the internal resistance of the first negative electrode plate is reduced, and the transmission kinetic performance of the lithium ion on the first negative electrode plate is improved. The first electrode assembly including the first negative electrode plate can be quickly fully charged at the high charging rate.

The second negative active material includes at least one of the graphite or the silicon-carbon composite material, and the mass percentage of the silicon in the silicon-carbon composite material ranges from 0.1% to 10%. For example, the mass percentage of the silicon in the silicon-carbon composite material is 0.1%, 1%, 2%, 3%, 4%, 5%, 6%, 7%, 8%, 9%, 10%, or any value within a range between any two values above. The foregoing material is selected as the second negative active material, so that the second negative electrode plate has a good capacity, and this further helps improve the energy density of the electrochemical apparatus.

In an implementation solution of this application, an average particle size Dv50₋₁ of the first negative active material ranges from 5 μm to 15 μm, and an average particle size Dv50₋₂ of the second negative active material ranges from 16 μm to 25 μm. For example, the average particle size Dv50₋₁ of the first negative active material is 5 μm, 7 μm, 9 μm, 11 μm, 13 μm, 15 μm, or any value within a range between any two values above. The average particle size Dv50₋₂ of the second negative active material is 16 μm, 18 μm, 20 μm, 22 μm, 23 μm, 25 μm, or any value within a range between any two values above. In this application, Dv50₋₁ and Dv50₋₂ represent particle sizes that start from a small particle size side and reach 50% of volume accumulation in volume-based particle size distribution.

In an implementation solution of this application, a difference between a coating weight Wiz of the first positive active material layer and a coating weight W_{2z} of the second positive active material layer satisfies: 50 mg/1540.25 mm²≤W_{2z}−W_{1z}≤190 mg/1540.25 mm², and preferably, 50 mg/1540.25 mm²≤W_{2z}−W_{1z}≤150 mg/1540.25 mm². For example, a value of W_{2z}−W_{1z} may be 50 mg/1540.25 mm², 60 mg/1540.25 mm², 90 mg/1540.25 mm², 110 mg/1540.25 mm², 130 mg/1540.25 mm², 150 mg/1540.25 mm², 190 mg/1540.25 mm², or any value within a range between any two values above.

In an implementation solution of this application, the coating weight Wiz of the first positive active material layer ranges from 90 mg/1540.25 mm² to 250 mg/1540.25 mm²; preferably, 150 mg/1540.25 mm² to 250 mg/1540.25 mm²; and more preferably, 170 mg/1540.25 mm² to 250 mg/1540.25 mm². For example, the coating weight Wiz of the first positive active material layer is 150 mg/1540.25 mm², 170 mg/1540.25 mm², 180 mg/1540.25 mm², 190 mg/1540.25 mm², 220 mg/1540.25 mm², 250 mg/1540.25 mm², or any value within a range between any two values above.

In an implementation solution of this application, a compaction density D_{1z} of the first positive active material layer ranges from 3.5 g/cm³ to 4.5 g/cm³. For example, the compaction density D_{1z} of the first positive active material layer is 4.05 g/cm³, 4.15 g/cm³, 4.23 g/cm³, or any value within a range between any two values above.

In an implementation solution of this application, the coating weight W_{2z} of the second positive active material layer ranges from 250 mg/1540.25 mm² to 315 mg/1540.25 mm². For example, the coating weight W_{2z} of the second positive active material layer is 250 mg/1540.25 mm², 280 mg/1540.25 mm², 310 mg/1540.25 mm², 315 mg/1540.25 mm², or any value within a range between any two values above.

In an implementation solution of this application, a compaction density D_{2z} of the second positive active material layer ranges from 3.5 g/cm³ to 4.5 g/cm³. For example, the compaction density D_{2z} of the second positive active material layer is 4.15 g/cm³, 4.18 g/cm³, 4.23 g/cm³, or any value within a range between any two values above.

In an implementation solution of this application, the first negative electrode plate is of any one of a multi-tab structure and a tab center-positioned structure.

In the multi-tab structure, a plurality of negative electrode tabs are connected to the first negative current collector. The “multi-tab” mentioned above refers to two or more tabs. In the tab center-positioned structure, the negative electrode tab is disposed between two ends in a length direction of the first negative active material layer. Disposal of the multi-tab structure or the tab center-positioned structure is more conducive to exponential shortening of a conduction path of a charge on the first negative electrode plate, so that the internal resistance of the first electrode assembly is effectively reduced, the rate performance of the first electrode assembly is improved, and the swelling performance of the electrochemical apparatus is improved.

In this application, the above-mentioned “tab” generally refers to a metal conductor that leads out from a positive electrode plate or a negative electrode plate and that is used to connect in series or parallel to another part of the electrochemical apparatus. A positive electrode tab leads out from the positive electrode plate, and a negative electrode tab leads out from the negative electrode plate. In this application, there is no special restriction on a material of the tab provided that the purpose of this application can be achieved. For example, a material of the positive electrode tab includes at least one of aluminum (Al) or aluminum alloys, and a material of the negative electrode tab includes at least one of nickel (Ni), copper (Cu), or nickel-plated copper (Ni—Cu). In this application, there is no special restriction on a connection mode between the tab and a current collector provided that the purpose of this application can be achieved. For example, the connection mode is at least one of laser welding, ultrasonic welding, resistance welding, one-piece molding, or the like. In this application, there is no special restriction on a leading-out direction of the tab provided that the purpose of this application can be achieved. For example, leading-out directions of tabs may be the same or different.

In an implementation solution of this application, the accommodation cavity includes a first cavity and a second cavity, a partition plate is provided between the first cavity and the second cavity, the first electrode assembly is disposed in the first cavity, and the second electrode assembly is disposed in the second cavity. In this way, the first cavity and the second cavity are cavities separated from each other, where the first cavity includes the first electrode assembly and an electrolyte solution, and the second cavity includes the second electrode assembly and an electrolyte solution, so that mutual interference of the first electrode assembly and the second electrode assembly during charging and discharging can be reduced, and stability of the charging and discharging of the electrochemical apparatus is improved. In addition, the partition plate separates the first electrode assembly from the second electrode assembly, so as to reduce a risk of an internal short circuit, in the electrochemical apparatus, caused by a contact between positive electrodes and negative electrodes of the first electrode assembly and the second electrode assembly during external impact such as dropping.

There is no special restriction on a type of the partition plate in this application provided that the purpose of this application can be achieved. For example, the partition plate includes at least one of a polymer material or a metal material. The polymer material includes at least one of polyethylene terephthalate, polybutylene terephthalate, polyethylene naphthalate, polyether ether ketone, polyimide, polyamide, polyethylene glycol, polyamide-imide, polycarbonate, cyclic polyolefin, polyphenylene sulfide, polyvinyl acetate, polytetrafluoroethylene, polymethylene naphthalene, polyvinylidene fluoride, polypropylene carbonate, Poly(vinylidene fluoride-hexafluoropropylene), poly(vinylidene fluoride-co-chlorotrifluoroethylene), organosilicone, vinylon, polypropylene, anhydride-modified polypropylene, polyethylene, ethylene and its copolymers, polyvinyl chloride, polystyrene, polyetheronitrile, polyurethane, polyphenylene ether, polyester, polysulfone, amorphous α-olefin copolymer, or a derivative of the above substance. The metal material includes at least one of Al, Ni, Ti, Ag, Au, Pt, Fe, Co, Cr, W, Mo, Pb, In, Zn, or stainless steel. There is no special restriction on a thickness of the partition plate in this application provided that the purpose of this application can be achieved. For example, the thickness of the partition plate ranges from 2 μm to 100 μm; preferably, 5 μm to 50 μm; and more preferably, 5 μm to 20 μm.

The first positive electrode plate of this application includes the first positive current collector and the first positive active material layer disposed on at least one surface of the first positive current collector, and this application has no special restriction on the first positive current collector provided that the purpose of this application can be achieved. The second positive electrode plate of this application includes the second positive current collector and the second positive active material layer disposed on at least one surface of the second positive current collector, and this application has no special restriction on the second positive current collector provided that the purpose of this application can be achieved. For example, the first positive current collector/second positive current collector may include aluminum foil, aluminum alloy foil, a composite current collector, or the like. There is no special restriction on a type of the first positive active material/second positive active material in this application provided that the purpose of this application can be achieved. For example, the first positive active material/second positive active material includes at least one of lithium nickel-cobalt-manganese oxide (811, 622, 523, 111), lithium nickel-cobalt-aluminum oxide, lithium iron phosphate, lithium cobalt oxide, lithium manganese oxide, or lithium manganese iron phosphate. In this application, there is no special restriction on thicknesses of the first positive current collector/second positive current collector and the first positive active material layer/second positive active material layer provided that the purpose of this application can be achieved. For example, the thickness of the first positive current collector/second positive current collector ranges from 5 μm to 20 μm, and preferably 6 μm to 18 μm. The thickness of the single-sided first positive active material layer/single-sided second positive active material layer ranges from 30 μm to 120 μm. In this application, the first positive active material layer/second positive active material layer may be disposed on one surface in a thickness direction of the first positive current collector/second positive current collector, or on two surfaces in the thickness direction of the first positive current collector/second positive current collector. It should be noted that the “surface” herein may be an entire area of the first positive current collector/second positive current collector, or a partial area of the first positive current collector/second positive current collector, and there is no special restriction on the surface in this application provided that the purpose of this application can be achieved. Optionally, the first positive electrode plate/second positive electrode plate may also include a conductive layer, and the conductive layer is located between the first positive current collector and the first positive active material layer/between the second positive current collector and the second positive active material layer. There is no special restriction on composition of the conductive layer, and the conductive layer can be a conductive layer commonly used in this art. The conductive layer includes a conductive agent and a binder.

The first negative electrode plate of this application includes the first negative current collector and the first negative active material layer disposed on at least one surface of the first negative current collector. There is no special restriction on the first negative current collector in this application provided that the purpose of this application can be achieved. The second negative electrode plate of this application includes the second negative current collector and the second negative active material layer disposed on at least one surface of the second negative current collector. There is no special restriction on the second negative current collector in this application provided that the purpose of this application can be achieved. For example, the first negative current collector/second negative current collector may include copper foil, copper alloy foil, nickel foil, stainless steel foil, titanium foil, nickel foam, copper foam, or a composite current collector. In this application, there is no special restriction on thicknesses of the first negative current collector/second negative current collector and the first negative active material layer/second negative active material layer provided that the purpose of this application can be achieved. For example, the thickness of the first negative current collector/second negative current collector ranges from 6 μm to 10 μm, and the thickness of the single-sided first negative active material layer/single-sided second negative active material layer ranges from 30 μm to 130 μm. In this application, the first negative active material layer/second negative active material layer may be disposed on one surface in a thickness direction of the first negative current collector/second negative current collector, or on two surfaces in the thickness direction of the first negative current collector/second negative current collector. It should be noted that the “surface” herein may be an entire region of the first negative current collector/second negative current collector, or a partial region of the first negative current collector/second negative current collector, and there is no special restriction on the surface in this application provided that the purpose of this application can be achieved. Optionally, the first negative electrode plate/second negative electrode plate may also include a conductive layer, and the conductive layer is located between the first negative current collector and the first negative active material layer/between the second negative current collector and the second negative active material layer. There is no special restriction on composition of the conductive layer, and the conductive layer may be a conductive layer commonly used in this art. The conductive layer includes a conductive agent and a binder.

There is no special restriction on the conductive agent provided that the purpose of this application can be achieved. For example, the conductive agent may include at least one of conductive carbon black, a carbon nanotube, a carbon nanofiber, graphite, acetylene black, Ketjen black, a carbon dot, or graphene. For example, the binder may include at least one of polypropylene glycol, sodium polyacrylate, potassium polyacrylate, lithium polyacrylate, polyimide, polyamideimide, styrene-butadiene rubber (SBR), polyvinyl alcohol (PVA), polyvinylidene fluoride (PVDF), polytetrafluoroethylene (PTFE), polyvinyl butyral (PVB), water-based acrylic resin, carboxymethylcellulose (CMC), or carboxymethyl cellulose sodium (CMC-Na).

The first electrode assembly of this application also includes a separator, and the separator is located between the first positive electrode plate and the first negative electrode plate. The second electrode assembly of this application also includes a separator, and the separator is located between the second positive electrode plate and the second negative electrode plate. The separators are respectively used to separate the first positive electrode plate and the first negative electrode plate, and separate the second positive electrode plate and the second negative electrode plate, so as to prevent an internal short circuit of a lithium-ion battery. The separators allow an electrolyte ion to pass freely, to complete an electrochemical charging and discharging process.

There is no special restriction on the separator in this application provided that the purpose of this application can be achieved. For example, the separator is at least one of a polyolefin (PO) separator mainly including polyethylene (PE) and polypropylene (PP), a polyester film (such as a polyethylene terephthalate (PET) film), a cellulose film, a polyimide (PI) film, a polyamide (PA) film, a spandex film, an aramid film, a woven film, a non-woven film (non-woven fabric), a microporous film, a composite film, a separator paper, a rolled film, a spun film, or the like. For example, the separator may include a substrate layer and a surface treatment layer. The substrate layer may be a non-woven fabric or a film or a composite film that is porous in structure, and a material of the substrate layer may include at least one of polyethylene, polypropylene, polyethylene terephthalate, polyimide, or the like. Optionally, the substrate layer may use at least one of a polypropylene porous film, a polyethylene porous film, a polypropylene non-woven fabric, a polyethylene non-woven fabric, a polypropylene-polyethylene-polypropylene porous composite film, or the like. Optionally, at least one surface of the substrate layer is provided with the surface treatment layer, and the surface treatment layer may be a polymer layer or an inorganic substance layer, or a layer formed by mixing a polymer and an inorganic substance. For example, the inorganic substance layer includes inorganic particles and a binder, and the inorganic particles are not particularly restricted, for example, may be selected from at least one of aluminum oxide, silicon oxide, magnesium oxide, titanium oxide, hafnium dioxide, tin oxide, cerium dioxide, nickel oxide, zinc oxide, calcium oxide, zirconia, yttrium oxide, silicon carbide, boehmite, aluminum hydroxide, magnesium hydroxide, calcium hydroxide, barium sulfate, or the like. There are no particular restriction on the binder. For example, the binder may be selected from at least one of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinylether, polymethyl methacrylate, polytetrafluoroethylene, and polyhexafluoropropylene. The polymer layer includes a polymer, and a material of the polymer includes at least one of polyamide, polyacrylonitrile, acrylate polymer, polyacrylic acid, polyacrylate, polyvinylpyrrolidone, polyvinylether, polyvinylidene fluoride, poly(vinylidene fluoride-hexafluoropropylene), or the like.

The electrochemical apparatus of this application also includes an electrolyte solution, and the electrolyte solution includes a lithium salt and a non-aqueous solvent. There is no special restriction on the lithium salt in this application provided that the purpose of this application can be achieved. For example, the lithium salt may include at least one of LiPF₆, LiBF₄, LiAsF₆, LiClO₄, LiB (C₆H₅)₄, LiCH₃SO₃, LiCF₃SO₃, LIN (SO₂CF₃)₂, LiC (SO₂CF₃)₃, LiSiF₆, LiBOB, or lithium difluoroborate. There is no special restriction on the non-aqueous solvent in this application provided that the purpose of this application can be achieved. For example, the non-aqueous solvent may be at least one of a carbonate compound, a carboxylic acid compound, an ether compound, or another organic solvent.

The carbonate compound may be at least one of a chained carbonate compound, a cyclic carbonate compound, or a fluorocarbonate compound. An example of the chained carbonate compound is at least one of dimethyl carbonate (DMC), diethyl carbonate (DEC), dipropyl carbonate (DPC), methylpropyl carbonate (MPC), ethylene propylene carbonate (EPC), or methyl ethyl carbonate (MEC). An example of the cyclic carbonate compound is at least one of ethylene carbonate (EC), propylene carbonate (PC), butylene carbonate (BC), or vinyl ethylene carbonate (VEC). An example of the fluorocarbonate compound is at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethyl carbonate, 1-fluoro-1-methylethylene carbonate, 1,2-difluoro-1-methylethylene carbonate, 1,1,2-trifluoro-2-methylethylene carbonate, or trifluoromethylethylene carbonate. An example of the carboxylic acid compound is at least one of methyl formate, methyl acetate, ethyl acetate, n-propyl acetate, tert-butyl acetate, methyl propionate, ethyl propionate, propyl propionate, γ-butyrolactone, decalactone, valerolactone, mevalonolactone, or caprolactone. An example of the ether compound is at least one of dibutyl ether, tetraethylene glycol dimethyl ether, diethylene glycol dimethyl ether, 1,2-dimethoxyethane, 1,2-diethoxyethane, ethoxymethoxyethane, 2-methyltetrahydrofuran, or tetrahydrofuran. An example of the another organic solvent is at least one of dimethyl sulfoxide, 1,2-dioxolane, sulfolane, methylsulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, or phosphate.

There is no special restriction on structures of the first electrode assembly and the second electrode assembly in this application provided that the purpose of this application can be achieved. For example, the structure of the first electrode assembly may include a winding structure or a laminated structure. The structure of the second electrode assembly may be the winding structure or the laminated structure. In this application, the structures of the first electrode assembly and the second electrode assembly may be the same or different. For example, in some embodiments of this application, the first electrode assembly is of the winding structure, and the second electrode assembly is of the winding structure. In other embodiments of this application, the first electrode assembly is of the laminated structure, and the second electrode assembly is of the laminated structure. In some still other embodiments of this application, the first electrode assembly is of the laminated structure, and the second electrode assembly is of the winding structure. In some still embodiments of this application, the first electrode assembly is of the winding structure, and the second electrode assembly is of the laminated structure.

In this application, there is no special restriction on the packaging shell provided that the purpose of this application can be achieved. For example, the packaging shell may include at least one of an aluminum plastic film, an aluminum shell, a steel shell, or a plastic shell.

In this application, there is no special restriction on a thickness of the packaging shell provided that the purpose of this application can be achieved. For example, the thickness of the packaging shell may be 60 μm to 500 μm; preferably, 60 μm to 300 μm; and more preferably, 60 μm to 200 μm. The above-mentioned thickness of the packaging shell can effectively protect an internal structure of the electrochemical apparatus.

There is no special restriction on the electrochemical apparatus in this application, and the electrochemical apparatus may include any apparatus in which an electrochemical reaction occurs. In some embodiments, the electrochemical apparatus may include, but is not limited to: a lithium metal secondary battery, a lithium-ion secondary battery (lithium-ion battery), a lithium-polymer secondary battery, a lithium-ion polymer secondary battery, or the like. A preparation process of the electrochemical apparatus is well known to those skilled in the art, and there is no special restriction in this application. For example, the process may include, but not limited to, the following steps: stacking the first positive electrode plate, the separator, and the first negative electrode plate in order, performing winding, folding, or other operations as needed to obtain the first electrode assembly of the winding structure, and putting the first electrode assembly into the packaging shell; stacking the second positive electrode plate, the separator, and the second negative electrode plate in order, performing winding, folding, or other operations as needed to obtain the second electrode assembly of the winding structure, and putting the second electrode assembly into the packaging shell; and separating the first electrode assembly and the second electrode assembly by the partition plate, and injecting the electrolyte solution into the packaging shell and sealing to obtain the electrochemical apparatus; or stacking the first positive electrode plate, the separator, and the first negative electrode plate in order, fixing four corners of the entire laminated structure with adhesive tape to obtain the first electrode assembly of the laminated structure, and placing the electrode assembly into the packaging shell; stacking the second positive electrode plate, the separator, and the second negative electrode plate in order, fixing four corners of the entire laminated structure with adhesive tape to obtain the second electrode assembly of the laminated structure, and placing the electrode assembly into the packaging shell; and separating the first electrode assembly and the second electrode assembly by the partition plate, and injecting the electrolyte solution into the packaging shell and sealing to obtain the electrochemical apparatus. In addition, an overcurrent prevention element, a guide plate, and the like may also be placed in the packaging shell as needed, thereby preventing pressure rise, overcharging and discharging inside the electrochemical apparatus.

A second aspect of this application provides an electronic apparatus including the electrochemical apparatus described in any of the foregoing implementation solutions of this application. Therefore, the electronic apparatus has high energy density and good swelling performance.

This application provides an electrochemical apparatus and an electronic apparatus including the electrochemical apparatus. The electrochemical apparatus includes: a packaging shell, a first electrode assembly, and a second electrode assembly, where the packaging shell is provided with an accommodation cavity, and the first electrode assembly and the second electrode assembly are disposed in the accommodation cavity; the first electrode assembly includes a first positive electrode plate and a first negative electrode plate, the first positive electrode plate includes a first positive current collector and a first positive active material layer disposed on at least one surface of the first positive current collector, and the first negative electrode plate includes a first negative current collector and a first negative active material layer disposed on at least one surface of the first negative current collector; the second electrode assembly includes a second positive electrode plate and a second negative electrode plate, the second positive electrode plate includes a second positive current collector and a second positive active material layer disposed on at least one surface of the second positive current collector, and the second negative electrode plate includes a second negative current collector and a second negative active material layer disposed on at least one surface of the second negative current collector; and a difference between a coating weight W_{1f} of the first negative active material layer and a coating weight War of the second negative active material layer satisfies: 30 mg/1540.25 mm²≤W_{2f}−W_{1f}≤100 mg/1540.25 mm². The electrochemical apparatus has high energy density and good swelling performance.

### BRIEF DESCRIPTION OF DRAWINGS

In order to clearly illustrate the technical solutions of the present application and the prior art, a brief description of drawings required in the embodiments and the prior art is set forth below.

Obviously, the drawings in the following description are merely illustrative of some embodiments of the present application.

FIG. 1 is a schematic diagram of an internal structure of an electrochemical apparatus according to an implementation solution of this application;

FIG. 2 is a schematic structural diagram of region A in FIG. 1;

FIG. 3 is a schematic structural diagram of a first positive electrode plate according to an implementation solution of this application; and

FIG. 4 is a schematic structural diagram of a first negative electrode plate in the solution in FIG. 3.

Reference numerals in specific implementations are as follows:
10—Packaging shell, 21—First electrode assembly, 211—First positive electrode plate, 212—First negative electrode plate, 22—Second electrode assembly, 230—Separator, 31—First cavity, 32—Second cavity, 40—Partition plate, 51—First positive electrode tab, 52—First negative electrode tab, and 100—Electrochemical apparatus.

### DETAILED DESCRIPTION

In order to make the objective, technical solution, and advantages of this application clearer, this application is further described in detail below with reference to the accompanying drawings and embodiments. Obviously, the described embodiments are only some embodiments of this application, not all embodiments. Based on the embodiments in this application, all other technical solutions obtained by a person of ordinary skill in the art belong to the scope of protection of this application.

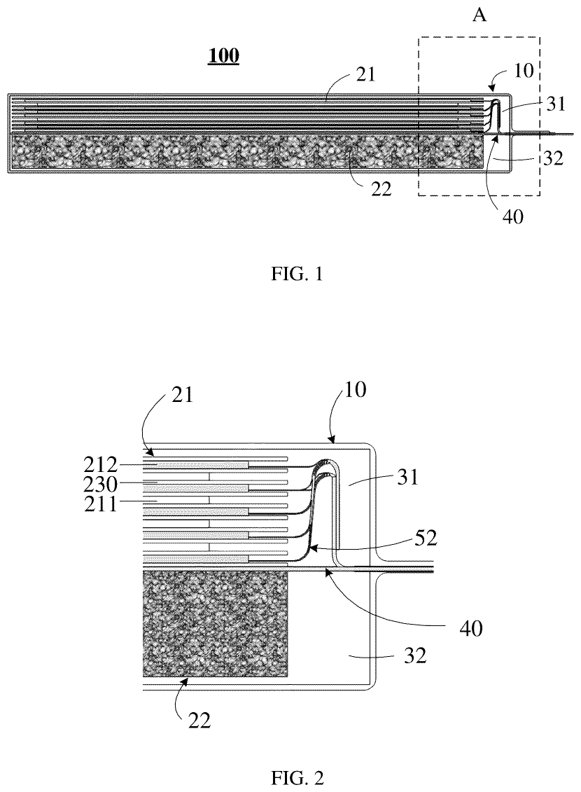

FIG. 1 is a schematic diagram of an internal structure of an electrochemical apparatus according to an implementation solution of this application. As shown in FIG. 1, the electrochemical apparatus 100 includes: a packaging shell 10, a first electrode assembly 21, and a second electrode assembly 22. The packaging shell 10 is provided with an accommodation cavity, and the accommodation cavity includes a first cavity 31 and a second cavity 32. A partition plate 40 is provided between the first cavity 31 and the second cavity 32, the first electrode assembly 21 is disposed in the first cavity 31, and the second electrode assembly 22 is disposed in the second cavity 32.

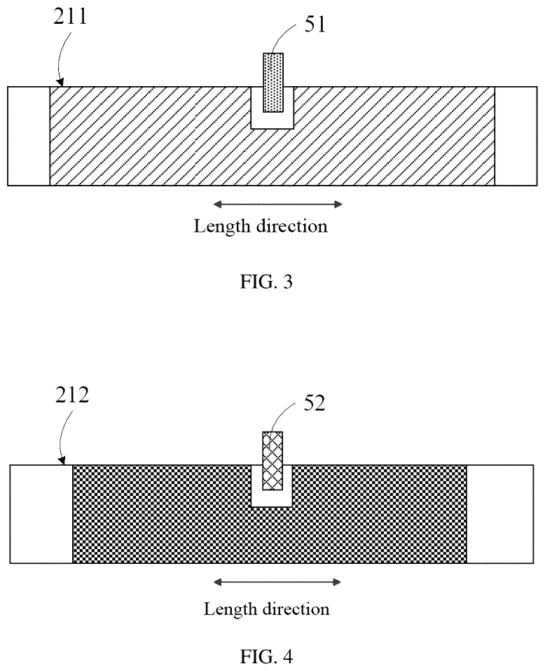

FIG. 2 is a schematic structural diagram of region A in FIG. 1. As shown in FIG. 2, a structure of the first electrode assembly 21 is a multi-tab structure. Specifically, in a jolly roll of the multi-tab structure formed by winding a first positive electrode plate 211, a separator 230, a first negative electrode plate 212, and a separator 230, the first positive electrode plate 211 includes a plurality of positive electrode tabs (not shown in the figure), and the first negative electrode plate 212 includes a plurality of negative electrode tabs 52. FIG. 3 is a schematic structural diagram of a first positive electrode plate according to some embodiments of this application. As shown in FIG. 3, a first positive electrode tab 51 is disposed between two ends in a length direction of a positive active material layer in the first positive electrode plate 211.

FIG. 4 is a schematic structural diagram of a first negative electrode plate according to some embodiments of this application. As shown in FIG. 4, a first negative electrode tab 52 is disposed between two ends in a length direction of a negative active material layer in the first negative electrode plate 212.

The structure of the first positive electrode plate 211 shown in FIG. 3 and the structure of the first negative electrode plate 212 shown in FIG. 4 are tab center-positioned structures.

It should be noted that in the specific implementations of the present application, the present application is explained by an example using a lithium-ion battery as an electrochemical apparatus, but the electrochemical apparatus of the present application is not limited to the lithium-ion battery.

### EMBODIMENT

Implementations of this application are described in more details below with reference to embodiments and comparative embodiments. Various tests and evaluations are performed according to the following methods.

### Measurement Methods and Devices

### Coating Weight Measurement:

(1) Cut out an electrode plate sample by using a standard tool (with an area 1540.25 mm²), put the sample on a balance to obtain a weight denoted as m1, then wash an active material layer on the electrode plate, and put a current collector on the balance to obtain a weight denoted as m².

(2) Coating weight calculation:

If the electrode plate is coated with an active material layer on one side, a coating weight=m1−m2.

If the electrode plate is coated with active material layers on both sides, a coating weight=(m1−m2)/2.

### Compaction Density Measurement:

(1) Cut out a regular electrode plate, record an area S1 (cm²), and record a thickness H1 (μm) of the electrode plate.

(2) Weigh the electrode plate and record a weight as M1 (mg).

(3) Wash an active material layer on the electrode plate to leave only a current collector, weigh the current collector, record a weight M2 (mg), and measure a thickness H2 (μm) of the current collector.

(4) Calculate compaction density of the electrode plate: Compaction density (g/cm³)=10×(M1−M2)/(S1×(H2−H1))

### Average Particle Size Measurement:

Measure an average particle size Dv50₋₁ of a first negative active material and an average particle size Dv50₋₂ of a second negative active material by using a laser particle size analyzer.

### Capacity Ratio and Energy Density Measurement of a First Electrode Assembly:

First, the first electrode assembly and the second electrode assembly are respectively charged based on the following operation process, and then discharged, and discharge capacities of the first electrode assembly and the second electrode assembly are obtained.

(1) Charge the first electrode assembly: charge to 4.2 V at 6 C, then charge to 4.43 V at 4 C, then charge to 4.48 V at 3 C, and charge to 1 C at a constant voltage.

(2) Charge the second electrode assembly: charge to 4.2 V at 2 C, then charge to 4.45 V at 1.3 C, and charge to 0.05 C at a constant voltage.

(3) Discharge the first electrode assembly: discharge to 3.0 V with a constant current of 1 C to obtain the discharge capacity C1.

(4) Discharge the second electrode assembly: discharge to 3.0 V with a constant current of 0.5 C to obtain the discharge capacity C2.

Capacity ratio of first electrode assembly=C1/(C1+C2)×100%

After the charging step of the second electrode assembly of a lithium-ion battery is completed, measure a length L, a width W, and a height H of the lithium-ion battery by using a laser thickness gauge to obtain a volume V=L×W×H of the lithium-ion battery. Volumetric energy density (ED) of the lithium-ion battery can be calculated according to the following formula: ED (Wh/L)=(C1+C2)/V.

### Thickness Swelling Rate Measurement:

Measure a thickness of a lithium-ion battery with state-of-charge (SOC)=0% by using a laser thickness gauge, where the thickness is denoted as T1, and then charge and discharge the first electrode assembly and the second electrode assembly in the lithium-ion battery for 500 cycles in the manner in <Capacity ratio and energy density measurement of a first electrode assembly>, and measure a final battery thickness as T500 by using the laser thickness gauge. Thickness swelling rate (%)=(T500−T1)/T1×100%

### Embodiment 1-1

### <Preparation of a First Negative Electrode Plate>

A first negative active material graphite, styrene-butadiene rubber, and sodium carboxymethyl cellulose are mixed in a mass ratio of 97:2:1, and deionized water is added, to prepare a slurry with a solid content of 70%, and the slurry is stirred evenly. The slurry is evenly coated on one surface of copper foil of a first negative current collector, and dried at 110° C., and then, and the above steps are repeated on the other surface of the copper foil of the first negative current collector, so that a first negative electrode plate coated with first negative active material layers on both sides is obtained. After the coating is completed, the first negative electrode plate is subjected to cold pressing and cut into a specification of 76 mm×851 mm, and tabs are welded for use. A coating weight W_{1f} of the first negative active material layer is 120 mg/1540.25 mm², a compaction density D_{1f} of the first negative active material layer is 1.55 g/cm³, a specific surface area BET₁ of the first negative active material is 1.9 m²/g, and an average particle size Dv50.1 of the first negative active material is 10 μm.

### <Preparation of a First Positive Electrode Plate>

A first positive active material lithium cobalt oxide (LiCoO₂), a conductive agent conductive carbon black, and a binder polyvinylidene fluoride (PVDF) are mixed in a mass ratio of 97.5:1.0:1.5, N-methylpyrrolidone (NMP) is added to prepare a slurry with a solid content of 75%, and the slurry is stirred evenly. The slurry is evenly coated on one surface of aluminum foil of a first positive current collector and dried at 130° C., and then, the above steps are repeated on the other surface of the aluminum foil of the first positive current collector, so that a positive electrode plate coated with first positive active material layers on both sides is obtained. After the coating is completed, the first positive electrode plate is subjected to cold pressing and cut into a specification of 74 mm×867 mm, and tabs are welded for use. A coating weight Wiz of the first positive active material layer is 220 mg/1540.25 mm², and a compaction density of the first positive active material layer D_{1z} is 4.05 g/cm³.

### <Preparation of a Second Negative Electrode Plate>

A second negative active material graphite, styrene-butadiene rubber, and sodium carboxymethyl cellulose are mixed in a mass ratio of 97:2:1, and deionized water is added, to prepare a slurry with a solid content of 70%, and the slurry is stirred evenly. The slurry is evenly coated on one surface of copper foil of a second negative current collector and dried at 110° C., and then, the above steps are repeated on the other surface of the copper foil of the second negative current collector, so that a second negative electrode plate coated with second negative active material layers on both sides is obtained. After the coating is completed, the second negative electrode plate is subjected to cold pressing and cut into a specification of 76 mm×851 mm, and tabs are welded for use. A coating weight W_{2f} of the second negative active material layer is 150 mg/1540.25 mm², a compaction density Der of the second negative active material layer is 1.75 g/cm³, a specific surface area BET₂ of the second negative active material is 0.9 m²/g, and an average particle size Dv50₋₂ of the second negative active material is 20 μm.

### <Preparation of a Second Positive Electrode Plate>

A second positive active material lithium cobalt oxide (LiCoO₂), a conductive agent conductive carbon black, and a binder polyvinylidene fluoride (PVDF) are mixed in a mass ratio of 97.5:1.0:1.5, and N-methylpyrrolidone (NMP) is added, to prepare a slurry with a solid content of 75%, and the slurry is stirred evenly. The slurry is evenly coated on one surface of aluminum foil of a second positive current collector and dried at 130° C., and then, the above steps are repeated on the other surface of the aluminum foil of the second positive current collector, so that a positive electrode plate coated with second positive active material layers on both sides is obtained. After the coating is completed, the second positive electrode plate is subjected to cold pressing and cut into a specification of 74 mm×867 mm, and tabs are welded for use. A coating weight W_{2z} of the second positive active material layer is 280 mg/1540.25 mm², and a compaction density of the second positive active material layer D_{2z} is 4.18 g/cm³

### <Preparation of an Electrolyte Solution>

In the atmosphere of dry argon, ethylene carbonate, methyl ethyl carbonate, and diethyl carbonate are mixed in a mass ratio of EC:EMC:DEC-30:50:20 to obtain an organic solution, and then lithium hexafluorophosphate is added to the organic solvent to dissolve and mix evenly to obtain an electrolyte solution in which a mass concentration of the lithium hexafluorophosphate is 12.5%.

### <Preparation of a Separator>

A polypropylene (PP) film with a thickness of 14 μm is adopted.

### <Preparation of a First Electrode Assembly>

The first positive electrode plate, the separator, and the first negative electrode plate that are prepared above are stacked in order, so that the separator is located between the first positive electrode plate and the first negative electrode plate for separation, and winding is performed to obtain the first electrode assembly. A structure of the first electrode assembly is a tab center-positioned structure.

### <Preparation of a Second Electrode Assembly>

The second positive electrode plate, the separator, and the second negative electrode plate that are prepared above are stacked in order, so that the separator is located between the second positive electrode plate and the second negative electrode plate for separation, and winding is performed to obtain the second electrode assembly.

### <Preparation of a Lithium-Ion Battery>

A piece of outer packaging (an aluminum plastic film with a thickness of 150 μm) molded through pouch forming is placed in a modular fixture, with a pouch surface facing upward, and the first electrode assembly is placed in the pouch. The second electrode assembly is placed on the first electrode assembly. Then, another piece of outer packaging (an aluminum plastic film with a thickness of 150 μm) with a pouch facing down covers the second electrode assembly, positive and negative electrode tabs of the first electrode assembly and the second electrode assembly are led out, and other positions of the outer packaging are subjected to heat-sealing after the side of an electrolyte injection port is reserved, where a heat-sealing temperature is 180° C. and a heat-sealing pressure is 0.5 MPa. The electrolyte solution is injected through the electrolyte injection port, and vacuum packaging, standing, formation, degassing, trimming, and other processes are performed to obtain the lithium-ion battery.

### Embodiment 1-2 to Embodiment 1-7 and Comparative Embodiment 1 and Comparative Embodiment 2

Except that the coating weight W_{1f} of the first negative active material layer, the coating weight W_{2f} of the second negative active material layer, the coating weight Wiz of the first positive active material layer, and the coating weight W_{2z} of the second positive active material layer are adjusted according to Table 1, the rest are the same as those in Embodiment 1-1.

### Embodiment 2-1 to Embodiment 2-6

Except that the specific surface area BET₁ and the average particle size Dv50₋₁ of the first negative active material and the specific surface area BET₂ and the average particle size Dv50₋₂ of the second negative active material are adjusted according to Table 2, the rest are the same as those in Embodiment 1-3.

### Embodiment 3-1 to Embodiment 3-3

Except that the coating weight W_{1f} of the first negative active material layer, the coating weight Wiz of the first positive active material layer, the coating weight W_{2f} of the second negative active material layer, a type of the second negative active material, the specific surface area BET₂ of the second negative active material, and the coating weight W_{2z} of the second positive active material layer are adjusted according to Table 3, the rest are the same as those in Embodiment 1-3.

Relevant preparation parameters and performance parameters in Embodiment 1-1 to Embodiment 1-7 and Comparative Embodiment 1 and Comparative Embodiment 2 are shown in Table 1, relevant preparation parameters and performance parameters in Embodiment 2-1 to Embodiment 2-6 are shown in Table 2, and relevant preparation parameters and performance parameters in Embodiment 3-1 to Embodiment 3-3 are shown in Table 3.

TABLE 1

| | First negative active | | First positive active | | Second negative active | | Second positive |
|---|---|---|---|---|---|---|---|
| | material layer | | material layer | | material layer | | active material layer |
| | W_{1f} (mg/ | D_{1f} | W_{1z} (mg/ | D_{1z} | W_{2f} (mg/ | D2f | W_{2z} (mg/ |
| | 1540.25 mm²) | (g/cm³) | 1540.25 mm²) | (g/cm³) | 1540.25 mm²) | (g/cm³) | 1540.25 mm²) |
| Embodiment | 120 | 1.55 | 220 | 4.05 | 150 | 1.75 | 280 |
| 1-1 | | | | | | | |
| Embodiment | 110 | 1.55 | 205 | 4.05 | 150 | 1.75 | 280 |
| 1-2 | | | | | | | |
| Embodiment | 100 | 1.55 | 190 | 4.05 | 150 | 1.75 | 280 |
| 1-3 | | | | | | | |
| Embodiment | 90 | 1.55 | 170 | 4.05 | 150 | 1.75 | 280 |
| 1-4 | | | | | | | |
| Embodiment | 80 | 1.55 | 150 | 4.05 | 150 | 1.75 | 280 |
| 1-5 | | | | | | | |
| Embodiment | 60 | 1.55 | 110 | 4.05 | 150 | 1.75 | 280 |
| 1-6 | | | | | | | |
| Embodiment | 50 | 1.55 | 90 | 4.05 | 150 | 1.75 | 280 |
| 1-7 | | | | | | | |
| Comparative | 120 | 1.55 | 220 | 4.05 | 130 | 1.75 | 240 |
| Embodiment 1 | | | | | | | |
| Comparative | 40 | 1.55 | 75 | 4.05 | 150 | 1.75 | 280 |
| Embodiment 2 | | | | | | | |

| | Second positive | | | Capacity | | |
|---|---|---|---|---|---|---|
| | active material layer | W_{2f} − W_{1f} | W_{2z} − W_{1z} | ratio of first | Thickness | Energy |
| | D_{2z} | (mg/1540.25 | (mg/1540.25 | electrode | swelling | density |
| | (g/cm³) | mm²) | mm²) | assembly (%) | rate (%) | (Wh/L) |
| Embodiment | 4.18 | 30 | 60 | 40 | 5.2 | 630 |
| 1-1 | | | | | | |
| Embodiment | 4.18 | 40 | 75 | 38 | 4.7 | 632 |
| 1-2 | | | | | | |
| Embodiment | 4.18 | 50 | 90 | 36 | 4.5 | 635 |
| 1-3 | | | | | | |
| Embodiment | 4.18 | 60 | 110 | 34 | 4.2 | 638 |
| 1-4 | | | | | | |
| Embodiment | 4.18 | 70 | 130 | 32 | 3.9 | 640 |
| 1-5 | | | | | | |
| Embodiment | 4.18 | 90 | 170 | 30 | 3.8 | 650 |
| 1-6 | | | | | | |
| Embodiment | 4.18 | 100 | 190 | 28 | 4.3 | 645 |
| 1-7 | | | | | | |
| Comparative | 4.18 | 10 | 20 | 48 | 8.6 | 620 |
| Embodiment 1 | | | | | | |
| Comparative | 4.18 | 110 | 205 | 25 | 5.4 | 610 |
| Embodiment 2 | | | | | | |

TABLE 2

| | First negative | | Second negative | | W_{2f} − | W_{2z} − | Capacity | | |
|---|---|---|---|---|---|---|---|---|---|
| | active material | | active material | | W_{1f}(mg/ | W_{1z}(mg/ | ratio of first | Thickness | Energy |
| | BET₁ | Dv50₋₁ | BET₂ | Dv50₋₂ | 1540.25 | 1540.25 | electrode | swelling | density |
| | (m²/g) | (μm) | (m²/g) | (μm) | mm²) | mm²) | assembly (%) | rate (%) | (Wh/L) |
| Embodiment 1-3 | 1.9 | 10 | 0.9 | 20 | 50 | 90 | 40 | 4.5 | 635 |
| Embodiment 2-1 | 1.6 | 15 | 0.9 | 20 | 50 | 90 | 40 | 3.6 | 640 |
| Embodiment 2-2 | 2.0 | 8 | 0.9 | 20 | 50 | 90 | 40 | 4.6 | 633 |
| Embodiment 2-3 | 2.5 | 5 | 0.9 | 20 | 50 | 90 | 38 | 4.9 | 630 |
| Embodiment 2-4 | 1.9 | 10 | 0.6 | 25 | 50 | 90 | 40 | 3.4 | 644 |
| Embodiment 2-5 | 1.9 | 10 | 1.0 | 18 | 50 | 90 | 40 | 4.2 | 632 |
| Embodiment 2-6 | 1.9 | 10 | 1.5 | 16 | 50 | 90 | 38 | 4.8 | 628 |

TABLE 3

| | First | | First | Second | | |
|---|---|---|---|---|---|---|
| | negative | | positive | negative | | |
| | active | | active | active | | |
| | material | | material | material | | |
| | layer | First | layer | layer | | |
| | W_{1f}(mg/ | negative | W_{1z}(mg/ | W_{2f}(mg/ | Second negative | |
| | 1540.25 | active | 1540.25 | 1540.25 | active material | |
| | mm²) | Type | mm²) | mm²) | Type | BET₂(m²/g) |
| Embodiment 1-3 | 100 | Graphite | 190 | 150 | Graphite | 0.9 |
| Embodiment 3-1 | 90 | Graphite | 170 | 130 | Silicon-carbon | 1.1 |
| | | | | | composite material | |
| | | | | | (W_{Si} = 0.1%) | |
| Embodiment 3-2 | 100 | Graphite | 190 | 150 | Silicon-carbon | 1.1 |
| | | | | | composite material | |
| | | | | | (W_{Si} = 5%) | |
| Embodiment 3-3 | 110 | Graphite | 205 | 170 | Silicon-carbon | 1.1 |
| | | | | | composite material | |
| | | | | | (W_{Si} = 10%) | |

| | Second | | | | | |
|---|---|---|---|---|---|---|
| | positive | | | | | |
| | active | | | | | |
| | material | | | Capacity | | |
| | layer | W_{2f} − | W_{2z} − | ratio of | | |
| | W_{2z}(mg/ | W_{1f}(mg/ | W_{1z}(mg/ | first | Thickness | Energy |
| | 1540.25 | 1540.25 | 1540.25 | electrode | swelling | density |
| | mm²) | mm²) | mm²) | assembly | rate (%) | (Wh/L) |
| Embodiment 1-3 | 280 | 50 | 90 | 40 | 4.5 | 635 |
| Embodiment 3-1 | 250 | 40 | 80 | 38 | 3.3 | 640 |
| Embodiment 3-2 | 270 | 50 | 80 | 36 | 3.5 | 645 |
| Embodiment 3-3 | 290 | 60 | 85 | 42 | 3.6 | 648 |

It can be seen from Embodiment 1-1 to Embodiment 1-7 and Comparative Embodiment 1 and Comparative Embodiment 2 that, swelling performance and energy density of the lithium-ion battery vary with a difference W_{2f}−W_{1f} between the coating weight W_{1f} of the first negative active material layer and the coating weight War of the second negative active material layer. A lithium-ion battery with W_{2f}−W_{1f} within the scope of this application has better swelling performance and better energy density than a lithium-ion battery with W_{2f}−W_{1f}<30 in Comparative Embodiment 1. Possible reasons are as follows: the coating weight War of the second negative active material layer is larger, in other words, in a same area, the second negative active material layer has more active materials than the first negative active material layer. Because accumulation between active material particles can provide more pores, when the first electrode assembly swells in a high-rate charge-discharge cycle process, the second negative active material layer can provide sufficient buffer space for the first electrode assembly, so that an overall volume increasing rate of the electrochemical apparatus is reduced, and swelling performance of the electrochemical apparatus is improved. By contrast, in Comparative embodiment 2 in which W_{2f}−W_{1f}>100, a low fast charging capacity cannot meet a requirement of a high-power consumption application. In addition, the coating weight W_{1f} of a first negative active material layer is too small relative to the coating weight W_{2f} of a second negative active material layer, which greatly reduces overall energy density of a lithium-ion battery, and when the coating weight W_{1f} of the first negative active material layer<50 mg/1540.25 mm², a degree of a side reaction between a surface of the first negative active material layer and an electrolyte solution increases, which also leads to a decrease in swelling performance.

It can be seen from Embodiment 1-3 and Embodiment 2-1 to Embodiment 2-6 that, there is more excellent swelling performance in Embodiment 1-3 and Embodiment 2-1 to Embodiment 2-2 with a first negative active material of which specific surface area BET₁ ranges from 1.6 m²/g to 2.0 m²/g than in Embodiment 2-3. The reasons are as follows: when the specific surface area of the first negative active material is within the above range, a requirement on a lithium ion deintercalation rate during high-rate charging and discharging is met, thereby reducing a side reaction such as lithium plating. In addition, an increase of a side reaction, between a surface of the negative active material and an electrolyte solution during charging and discharging, due to an excessively large specific surface can be reduced, thereby improving the swelling performance. There is higher energy density in Embodiment 1-3, Embodiment 2-4, and Embodiment 2-5 with a second negative active material of which specific surface area BET₂ ranges from 0.6 m²/g to 1.1 m²/g than in Embodiment 2-6. In addition, because a contact area with the electrolyte solution is small during charging and discharging, few side reactions occur, so that the good swelling performance is achieved.

It can be seen from Embodiment 1-3, and Embodiment 3-1 to Embodiment 3-3 that, there are also good swelling performance and higher energy density in Embodiment 3-1 to Embodiment 3-3 with a second negative active material of which type is of a silicon-carbon composite material and when W_{2f}−W_{1f} is within the scope of this application.

It should be noted that, in this specification, relational terms such as “first” and “second” are merely used to distinguish one entity from another entity, and do not necessarily require or imply any such actual relationship or order between these entities. Further, the terms “include”, “contain”, or any other variation thereof are intended to cover non-exclusive inclusion, so that an article or device that includes a series of elements includes not only those elements, but also other elements that are not expressly listed, or further includes elements inherent to such article or device.

Each embodiment in this specification is described in a related manner, the same and similar parts between embodiments can refer to each other, and each embodiment focuses on differences with other embodiments.

The above description is only the preferred embodiment of the present application and is not be used to limit the present application. Any modifications, equivalent replacements, improvements, etc. made within the spirit and principle of the present application are to be included within the scope of protection of the present application.

What is claimed is:

1. An electrochemical apparatus, comprising:
a packaging shell, wherein the packaging shell is provided with an accommodation cavity; and
a first electrode assembly and a second electrode assembly, wherein the first electrode assembly and the second electrode assembly are disposed in the accommodation cavity; wherein
the first electrode assembly comprises a first positive electrode plate and a first negative electrode plate, the first positive electrode plate comprises a first positive current collector and a first positive active material layer disposed on at least one surface of the first positive current collector, and the first negative electrode plate comprises a first negative current collector and a first negative active material layer disposed on at least one surface of the first negative current collector;
the second electrode assembly comprises a second positive electrode plate and a second negative electrode plate, the second positive electrode plate comprises a second positive current collector and a second positive active material layer disposed on at least one surface of the second positive current collector, and the second negative electrode plate comprises a second negative current collector and a second negative active material layer disposed on at least one surface of the second negative current collector; and
a difference between a coating weight W_{1f} of the first negative active material layer and a coating weight W_{2f} of the second negative active material layer satisfies: 30 mg/1540.25 mm²≤W_{2f}−W_{1f}≤100 mg/1540.25 mm².

2. The electrochemical apparatus according to claim 1, wherein the electrochemical apparatus satisfies at least one of the following conditions:
(1) the coating weight W_{1f} of the first negative active material layer ranges from 50 mg/1540.25 mm² to 140 mg/1540.25 mm²; or
(2) a compaction density D_{1f} of the first negative active material layer ranges from 1.5 g/cm³ to 1.8 g/cm³.

3. The electrochemical apparatus according to claim 1, wherein the electrochemical apparatus satisfies at least one of the following conditions:
(3) the coating weight W_{2f} of the second negative active material layer ranges from 130 mg/1540.25 mm² to 170 mg/1540.25 mm²; or
(4) a compaction density Der of the second negative active material layer ranges from 1.5 g/cm³ to 1.8 g/cm³.

4. The electrochemical apparatus according to claim 1, wherein the first negative active material layer comprises a first negative active material, the second negative active material layer comprises a second negative active material, and satisfying at least one of the following conditions:
(a) a specific surface area BET₁ of the first negative active material ranges from 1.6 m²/g to 2.0 m²/g;
(b) a specific surface area BET₂ of the second negative active material ranges from 0.6 m²/g to 1.1 m²/g;
(c) the first negative active material comprises at least one of graphite or lithium titanate; or
(d) the second negative active material comprises at least one of the graphite or a silicon-carbon composite material, and a mass percentage W_{Si} of silicon in the silicon-carbon composite material ranges from 0.1% to 10%.

5. The electrochemical apparatus according to claim 4, wherein an average particle size Dv50₋₁ of the first negative active material ranges from 5 μm to 15 μm, and an average particle size Dv50₋₂ of the second negative active material ranges from 16 μm to 25 μm.

6. The electrochemical apparatus according to claim 1, wherein a difference between a coating weight Wiz of the first positive active material layer and a coating weight W_{2z} of the second positive active material layer satisfies: 50 mg/1540.25 mm²≤W_{2z}−W_{1z}≤150 mg/1540.25 mm².

7. The electrochemical apparatus according to claim 6, wherein the electrochemical apparatus satisfies at least one of the following conditions:
(e) the coating weight Wiz of the first positive active material layer ranges from 150 mg/1540.25 mm² to 250 mg/1540.25 mm²;
(f) a compaction density D_{1z} of the first positive active material layer ranges from 3.5 g/cm³ to 4.5 g/cm³;
(g) the coating weight W_{2z} of the second positive active material layer ranges from 250 mg/1540.25 mm² to 315 mg/1540.25 mm²; or
(h) a compaction density D_{2z} of the second positive active material layer ranges from 3.5 g/cm³ to 4.5 g/cm³.

8. The electrochemical apparatus according to claim 1, wherein the first negative electrode plate is of a multi-tab structure or a tab center-positioned structure.

9. The electrochemical apparatus according to claim 1, wherein the accommodation cavity comprises a first cavity and a second cavity, a partition plate is provided between the first cavity and the second cavity, the first electrode assembly is disposed in the first cavity, and the second electrode assembly is disposed in the second cavity.

10. The electrochemical apparatus according to claim 9, wherein the partition plate comprises at least one of a polymer material or a metal material.

11. An electronic apparatus, comprising an electrochemical apparatus, the electrochemical apparatus comprises:
a packaging shell, wherein the packaging shell is provided with an accommodation cavity; and
a first electrode assembly and a second electrode assembly, wherein the first electrode assembly and the second electrode assembly are disposed in the accommodation cavity; wherein
the first electrode assembly comprises a first positive electrode plate and a first negative electrode plate, the first positive electrode plate comprises a first positive current collector and a first positive active material layer disposed on at least one surface of the first positive current collector, and the first negative electrode plate comprises a first negative current collector and a first negative active material layer disposed on at least one surface of the first negative current collector;
the second electrode assembly comprises a second positive electrode plate and a second negative electrode plate, the second positive electrode plate comprises a second positive current collector and a second positive active material layer disposed on at least one surface of the second positive current collector, and the second negative electrode plate comprises a second negative current collector and a second negative active material layer disposed on at least one surface of the second negative current collector; and
a difference between a coating weight W_{1f} of the first negative active material layer and a coating weight W_{2f} of the second negative active material layer satisfies: 30 mg/1540.25 mm²≤W_{2f}−W_{1f}≤100 mg/1540.25 mm².

12. The electronic apparatus according to claim 11, wherein the electrochemical apparatus satisfies at least one of the following conditions:
(1) the coating weight W_{1f} of the first negative active material layer ranges from 50 mg/1540.25 mm² to 140 mg/1540.25 mm²; or
(2) a compaction density Dir of the first negative active material layer ranges from 1.5 g/cm³ to 1.8 g/cm³.

13. The electronic apparatus according to claim 11, wherein the electrochemical apparatus satisfies at least one of the following conditions:
(3) the coating weight W_{2f} of the second negative active material layer ranges from 130 mg/1540.25 mm² to 170 mg/1540.25 mm²; or
(4) a compaction density D_{2f} of the second negative active material layer ranges from 1.5 g/cm³ to 1.8 g/cm³.

14. The electronic apparatus according to claim 11, wherein the first negative active material layer comprises a first negative active material, the second negative active material layer comprises a second negative active material, and satisfying at least one of the following conditions:
(a) a specific surface area BET₁ of the first negative active material ranges from 1.6 m²/g to 2.0 m²/g;
(b) a specific surface area BET₂ of the second negative active material ranges from 0.6 m²/g to 1.1 m²/g;
(c) the first negative active material comprises at least one of graphite or lithium titanate; or
(d) the second negative active material comprises at least one of the graphite or a silicon-carbon composite material, and a mass percentage W_{Si} of silicon in the silicon-carbon composite material ranges from 0.1% to 10%.

15. The electronic apparatus according to claim 14, wherein an average particle size Dv50₋₁ of the first negative active material ranges from 5 μm to 15 μm, and an average particle size Dv50₋₂ of the second negative active material ranges from 16 μm to 25 μm.

16. The electronic apparatus according to claim 11, wherein a difference between a coating weight W_{1z} of the first positive active material layer and a coating weight W_{2z} of the second positive active material layer satisfies: 50 mg/1540.25 mm²≤W_{2z}−W_{1z}≤150 mg/1540.25 mm².

17. The electronic apparatus according to claim 16, wherein the electrochemical apparatus satisfies at least one of the following conditions:
(e) the coating weight Wiz of the first positive active material layer ranges from 150 mg/1540.25 mm² to 250 mg/1540.25 mm²;
(f) a compaction density D_{1z} of the first positive active material layer ranges from 3.5 g/cm³ to 4.5 g/cm³;
(g) the coating weight W_{2z} of the second positive active material layer ranges from 250 mg/1540.25 mm² to 315 mg/1540.25 mm²; or
(h) a compaction density D_{2z} of the second positive active material layer ranges from 3.5 g/cm³ to 4.5 g/cm³.

18. The electronic apparatus according to claim 11, wherein the first negative electrode plate is of a multi-tab structure or a tab center-positioned structure.

19. The electronic apparatus according to claim 11, wherein the accommodation cavity comprises a first cavity and a second cavity, a partition plate is provided between the first cavity and the second cavity, the first electrode assembly is disposed in the first cavity, and the second electrode assembly is disposed in the second cavity.

20. The electronic apparatus according to claim 19, wherein the partition plate comprises at least one of a polymer material or a metal material.
